(19) United States
(12) Patent Application Publication
(10) Pub. No.: US 2026/0095448 A1
(43) Pub. Date: Apr. 2, 2026

(54) GRANULARITY LEAST PRIVILEGE ACCESS MECHANISMS

(71) Applicant: Fortinet, Inc., Sunnyvale, CA (US)

(72) Inventors: Fabio Baptista Gallego, Sao Paulo (BR); Cedrick Mendes, Sao Paulo (BR)

(73) Assignee: Fortinet, Inc., Sunnyvale, CA (US)

(21) Appl. No.: 18/901,455

(22) Filed: Sep. 30, 2024

(51) Int. Cl. H04L 9/40

(52) U.S. Cl. CPC H04L 63/10

(57) ABSTRACT

Approaches to managing permissions in a cloud-based computing environment are disclosed. Data corresponding to the usage of permissions is collected. The permissions are utilized to access resources in a cloud-based computing environment that provides secure resources and services based, at least in part, on permissions associated with a requesting entity. The collected data is analyzed utilizing one or more pre-selected parameters to determine usage levels for the permissions. An evaluation is performed to determine whether one or more usage levels for the permissions is outside of a usage window for the corresponding permissions. A report of permissions having usage levels outside of the usage window for the corresponding permissions is generated. The report is transmitted to an entity having some responsibility with respect to the usage of permissions.

### BACKGROUND

Various security mechanisms are used to manage who or what can access resources and/or services (e.g., cloud-based resources and/or services). In complex environments, the number of permission configurations can become quite large and difficult for administrators to provide the precise combination of permissions that is appropriate for a given entity. As a result, the set of permissions granted to an entity is often in excess of the ideal least privilege configuration. This can lead to security vulnerabilities.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an architecture that can provide improved granularity least privilege access.

FIG. 2 is a flow diagram of a portion of an approach to provide improved granularity least privilege access.

FIG. 3 is a flow diagram of a portion of an approach to provide improved granularity least privilege access.

FIG. 4A is a flow diagram of a portion of an approach to provide improved granularity least privilege access.

FIG. 4B is a flow diagram of a portion of an approach to provide improved granularity least privilege access.

FIG. 5 illustrates a first example report.

FIG. 6 illustrates a second example report.

FIG. 7 illustrates a third example report.

FIG. 8 is an example of a system to a portion of an approach to provide improved granularity least privilege access.

FIG. 9 is an example of a system to a portion of an approach to provide improved granularity least privilege access.

FIG. 10 is a block diagram that illustrates a computer system in which or with which an embodiment of the present disclosure may be implemented.

### TERMS AND DEFINITIONS

Brief definitions of terms used throughout this application are given below.

The term “client” generally refers to an application, program, process, or device in a client/server relationship that requests information or services from another program, process, or device (a server) on a network. Importantly, “client” and “server” are relative since an application may be a client to one application but a server to another. The term “client” also encompasses software that makes the connection between a requesting application, program, process, or device to a server possible, such as a file transfer protocol (FTP) client.

The phrase “endpoint protection platform” generally refers to cybersecurity monitoring and/or protection functionality performed on behalf of an endpoint (or client) device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and leverage code-tracing technology to detect advanced threats such as in-memory malware. The endpoint protection platform may provide monitoring and/or protection functionality on behalf of the endpoint device via an agent, which may be referred to herein as an “endpoint security agent” deployed on the endpoint device. Non-limiting examples of an endpoint protection platform include the FORTIEDR Software as a Service (SaaS) platform and the FORTICLIENT integrated endpoint protection platform available from Fortinet, Inc. of Sunnyvale, CA. In some examples, the endpoint protection platform is a participant in a cybersecurity mesh architecture (CSMA) in which various cybersecurity products/solutions/tools of a given cybersecurity or networking security vendor or across a group of participating vendors achieve a more integrated security policy by facilitating interoperability and communication among the various cybersecurity products/solutions/tools (e.g., network security appliances, a secure access service edge (SASE) platform, etc.).

The phrase “endpoint security agent” generally refers to endpoint software that runs on an endpoint device (e.g., a desktop computer, a laptop computer, or a mobile device) and monitors for cybersecurity issues arising on the endpoint device and/or protects the endpoint device against cybersecurity issues. In some examples, the endpoint security agent may be deployed on the endpoint device as a fabric agent that delivers protection, compliance, and secure access in a single, modular, lightweight client. A fabric agent may be endpoint software that runs on an endpoint device and communicates with a telemetry connection or a cybersecurity mesh (e.g., the Fortinet Security Fabric available from Fortinet, Inc. of Sunnyvale, CA) to provide information, visibility, and control to that device. In some examples, the endpoint security agent may be in the form of a lightweight endpoint agent that utilizes less than one percent of CPU and less than 100 MB of RAM and may leverage, among other things, various security event classification sources provided within one or more associated cloud-based security services.

A non-limiting example of an endpoint security agent is the FORTICLIENT Fabric Agent available from Fortinet, Inc. of Sunnyvale, CA. In one example, to simplify the initial deployment and offload ongoing monitoring, an endpoint security agent may be managed and/or supported by one or more endpoint-focused managed services, for example, to provide setup, deployment, configuration, vulnerability monitoring, and overall endpoint security monitoring. In the context of a CSMA, the endpoint security agent may communicate with an endpoint protection platform, one or more network security appliances, and/or one or more cloud-based security services via a telemetry connection and/or via application programming interface (API) integration. In some examples, the endpoint security agent enables remote workers to connect to the network using zero-trust principles securely and may enable both Universal ZTNA and Virtual Private Network (VPN)-encrypted tunnels, as well as URL filtering and cloud access security broker (CASB). The endpoint security agent may additionally provide enhanced security capabilities through artificial intelligence (AI)-based NGAV, endpoint quarantine, and application firewall, as well as support for cloud sandbox, USB device control, and ransomware protection.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software to perform one or more security functions. Other network security devices may include custom hardware (e.g., one or more custom Application-Specific Integrated Circuits (ASICs)).

For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, and NPs. Mid-range network security devices may include one or more multi-core CPUs, one or more separate NP Application-Specific Integrated Circuits (ASICs), and one or more CP ASICs. At the high end, network security devices may have multiple NPs and/or multiple CPs. A network security device is typically associated with a particular network (e.g., a private enterprise network) on behalf of which it provides one or more security functions.

Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations as a unified threat management (UTM) solution.

Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

As used herein, “cloud-native protection” generally refers to a set of technologies and functionalities that enable integration with cloud service provider security services to deliver a full-stack cloud security solution. This can include analyzing security findings and alerts from multiple security services to provide actionable insights. This can include delivering real-time thread protection with zero-permission security coverage. This can include detection and protection against malware, sensitive data, data loss and/or misconfiguration in cloud storage repositories. This can include protection against vulnerabilities in container images and/or registries. A non-limiting example of a cloud-native protection architecture is the FORTICNP available from Fortinet, Inc. of Sunnyvale, CA.

As used herein, “Zero-Trust Network Access” or “ZTNA” generally refers to a set of technologies and functionalities that enable secure access to internal applications for local or remote users (e.g., utilizing on-net endpoint or client devices within an enterprise network or off-net endpoint or client devices outside of the enterprise network, respectively). ZTNA represents the evolution of VPN remote access, bringing the zero-trust model to application access. ZTNA may be used to authenticate and authorize access to resources based on identity, device, and/or contextual data. ZTNA solutions typically grant access on a per-session basis to individual applications only after devices and users are verified.

As used herein, a “ZTNA Access Point” or “ZTNA AP” generally refers to any hardware device, software application, or combination of hardware and software that may be used to control access to protected network devices, servers, resources, services, TCP applications, and/or databases by a requesting endpoint device. In some cases, a ZTNA AP runs one or more access proxies, including a TFAP. Depending on the particular implementation, a ZTNA may be provided in virtual or physical form. For example, a ZTNA AP may be a virtual node or container that runs one or more access proxies or a network security appliance (e.g., a UTM appliance) that runs one or more access proxies.

As used herein, a “secure connection” generally refers to a connection provided through a computer network by one or more protocols that secure communication and data transfers via the connection, for example, via end-to-end encryption. Non-limiting examples by which a secure connection may be established include HTTPS, Hypertext Transport Protocol version 1.1 (HTTP 1.1) over SSL, Hypertext Transfer Protocol version 2.0 (HTTP 2.0) over SSL, Hypertext Transfer Protocol version 3.0 (HTTP 3.0) over Quick User Datagram Protocol (UDP) Internet Connections (QUIC).

A “computer” or “computer system” may be one or more physical computers, virtual computers, or computing devices. As an example, a computer may be one or more server computers, cloud-based computers, cloud-based clusters of computers, virtual machine instances, or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers unless expressly stated otherwise.

The terms “connected” or “coupled” and related terms are used in an operational sense and are not necessarily limited to a direct connection or coupling. Thus, for example, two devices may be coupled directly or via one or more intermediary media or devices. As another example, devices may be coupled so that information can be passed between them without sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” "in an example," “in some examples,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

### DETAILED DESCRIPTION

As described in greater detail below, various approaches and mechanisms are presented that can be responsible for permission analysis and can provide deep security visibility across cloud infrastructures and can provide features to generate and/or transmit alerts regarding risks in the cloud environment (e.g., public clouds). Cloud environments provide various mechanisms for identifying users and for access management. Because cloud environments can support a large number of client devices as well as a large number of servers and resources, the resulting number of permission configurations can become quite large and difficult for administrators to provide the precise combination of permissions that is appropriate for a given entity.

Because of the number of permission combinations available, it is difficult for administrators to create a security policy with only the permissions needed within desired timeframes. A common result is that permission configuration is achieved via trial-and-error and/or providing excess permissions to ensure that adequate permissions are granted. This presents a security vulnerability, and studies have shown that the higher the privilege levels the higher the security risks. Thus, improved approaches and mechanisms are desirable.

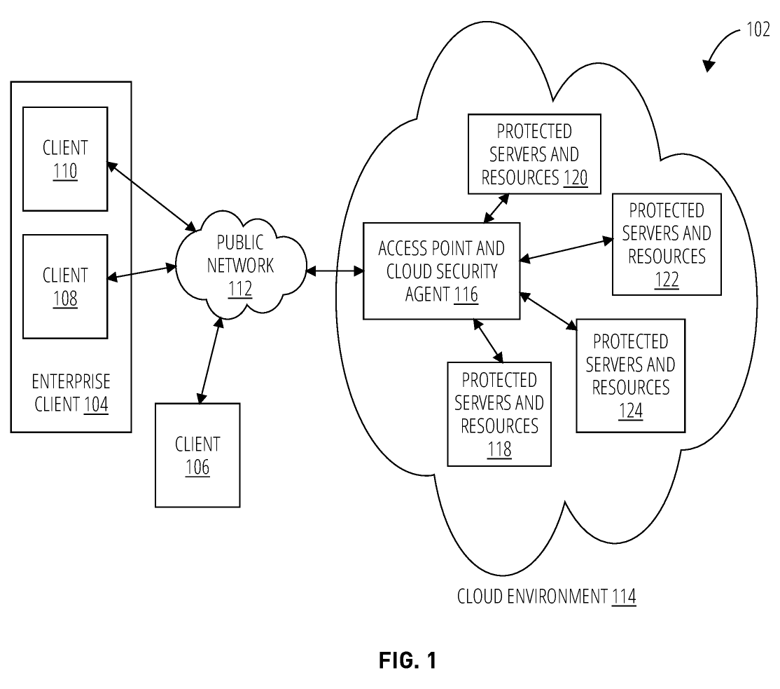

FIG. 1 is a block diagram of an architecture that can provide improved granularity least privilege access. In the context of the present example, multiple off-net clients (e.g., client 110, client 108, client 106) access cloud environment 114 via public network 112 (e.g., the Internet). The off-net clients may represent endpoint or client devices (e.g., workstations, desktop computers, laptop computers, or mobile devices) used by remote workers associated with a particular organization or enterprise.

In an example, cloud environment 114 includes access point and cloud security agent 116, protected servers and resources 118, protected servers and resources 120, protected servers and resources 122, and protected servers and resources 124. Additional and/or different components can be included in cloud environment 114. In an example, access point and cloud security agent 116 may be responsible for controlling access to one or more of protected servers and resources 118, protected servers and resources 120, protected servers and resources 122, and protected servers and resources 124, which may be based on various permissions associated with a user, a user device, a user organization, etc. In an example, these permissions are managed and/or enforced via access point and cloud security agent 116.

In an example, client devices (e.g., client 106, client 108, client 110) belonging to enterprise client 104 can be utilized to access cloud environment 114 via public network 112. Any number of client devices and/or enterprise clients can be supported. In an example, requests from client devices are evaluated based on various considerations including, for example, user permissions, device permissions, organization permissions, user groups, role permissions, geographic permissions, policies etc. As described above the set of permissions associated with the requests may exceed the least privilege level of permissions (which may be a desirable level for security purposes). While this excess privilege condition may allow a request to be serviced appropriately, the privileges associated with the user, device, organization, user group, role, policies and/or geography may be excessive leading to the potential of a security vulnerability.

As described in greater detail below, there is provided herein mechanisms (and corresponding approaches) to check (or audit) permissions assigned to an entity. This check (or audit) can determine permissions not used within a preselected set of parameters (e.g., time, geographic location, role) and alert security administrators that permissions can be reduced while still providing the desired level of access. In another configuration, the permissions may be automatically modified based on the check/audit. In an example, the permissions are managed an maintained with in cloud environment 114 and the check/audit result information can be utilized to reconfigure the cloud-based (e.g., cloud-native) permission configurations.

In an example, using the approaches described, cloud administrators (or other entities) can configure a least privilege level of permissions, which can improve the security of the cloud environment. In an example, an iterative approach can be applied where the parameters used for the permission check/audit can be revised (e.g., tightened) over time to improve security.

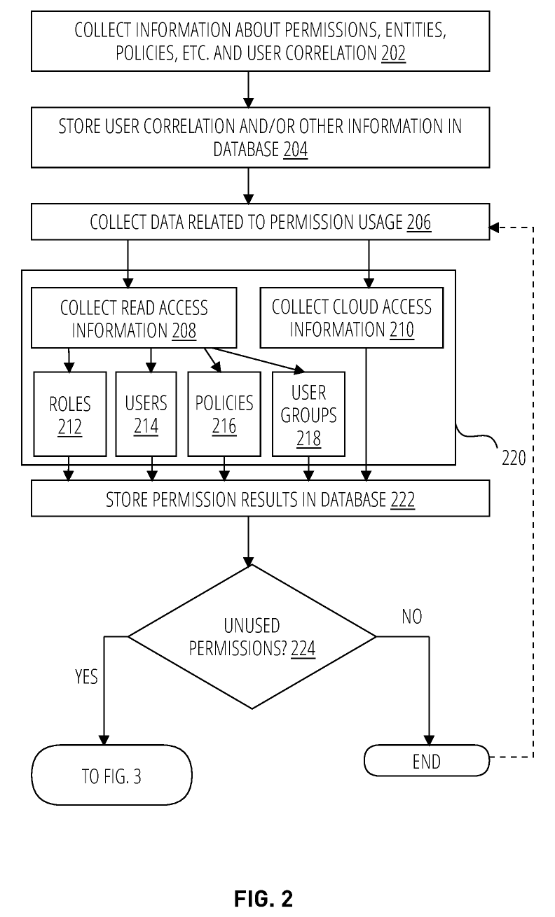

FIG. 2 is a flow diagram of a portion of an approach to provide improved granularity least privilege access. In an example, the approach described can provided in which a security entity external to the cloud services environment (e.g., not associated with the cloud services provider) can manage various permissions and/or other security/access settings from outside the cloud services environment. In an example, this can be accomplished using various application program interfaces (APIs) provided to access the cloud services environment and/or various commands.

In an example, a tool is utilized to collect information about entities, permissions and/or policies, etc., 202. In an example, the collected information can be correlated to a user or other entity. Permissions can include, for example, access privileges for various files or services, characteristics of various entities authorized to access various files or services, groupings of entities having the same or similar permissions, roles of entities and corresponding permissions. The collected information is stored in a database, 204.

Permission usage information is collected, 206. Various techniques can be utilized to collect the permission usage information. Some example techniques are described below. In general, the specific permissions, permission properties, techniques for determining permission usage and/or interfaces for collecting information is at least partially dependent upon the cloud service provider being accessed. One example cloud service provider is Amazon Web Services, Inc. (AWS), which is a subsidiary of Amazon.com, Inc. of Bellevue, Washington, USA, that provides on-demand cloud computing platforms and APIs to individuals, companies, and governments, on a metered, pay-as-you-go basis. One of the foundational services is Amazon Elastic Compute Cloud (EC2), which allows users to have at their disposal a virtual cluster of computers, with extremely high availability, which can be interacted with over the internet via REpresentational State Transfer (REST) APIs, a command line interface (CLI) or the AWS console.

AWS is just one example cloud service provider environment in which the techniques described herein can be utilized. Other cloud service providers include, as further examples, Azure available from Microsoft Corp. of Redmond, Washington, USA, Google Cloud available from Google Inc. of Menlo Park, California, USA, Alibaba Cloud available from the Alibaba Group of Hangzhou, China, IBM Cloud available from IBM, Corp. of Armonk, New York, USA, Oracle Cloud available from Oracle Corp. of Austin, Texas, USA, CenturyLink Cloud available from Lumen Technologies, Inc. of Monroe, Louisiana, USA, etc.

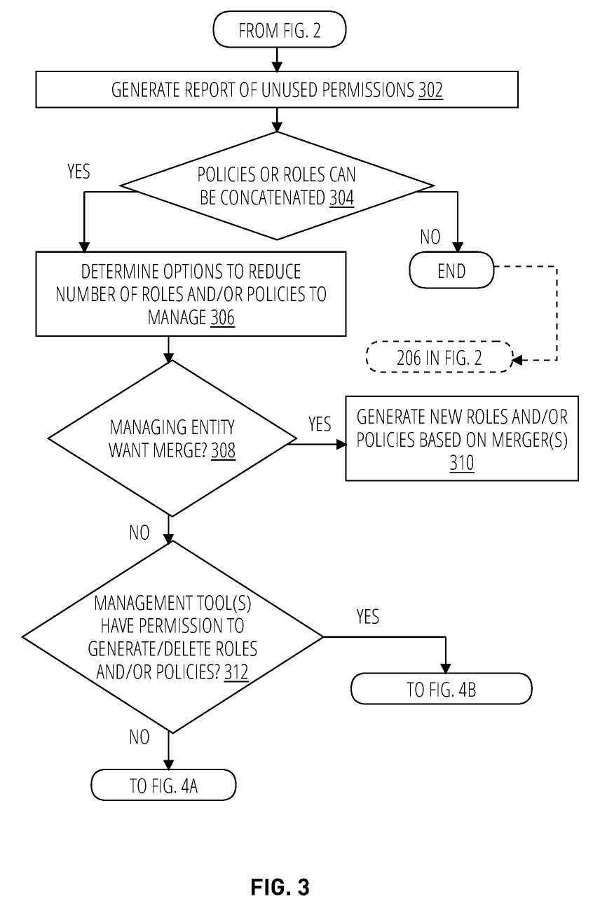

In an example, read access information is collected, 208, for roles 212, users 214, policies 216 and/or user groups 218. The collected read access results are stored in a database, 222. Similarly, cloud access information is collected, 210. The collected cloud access information is stored in the database, 222. In an example, cloud service provider interface 220 includes one or more APIs, instructions, commands and/or other capabilities to collect the permission information as described. If there are no unused permissions, 224, the process ends. In an example, when the flow ends, it can be repeated in response to some triggering condition (e.g., a period of time, a explicit command, a change is some other condition). If unused permissions have been identified, 224, the process continues as described in FIG. 3.

FIG. 3 is a flow diagram of a portion of an approach to provide improved granularity least privilege access. The flow of FIG. 3 continues the flow of FIG. 2 when unused permissions are identified (224 in FIG. 2).

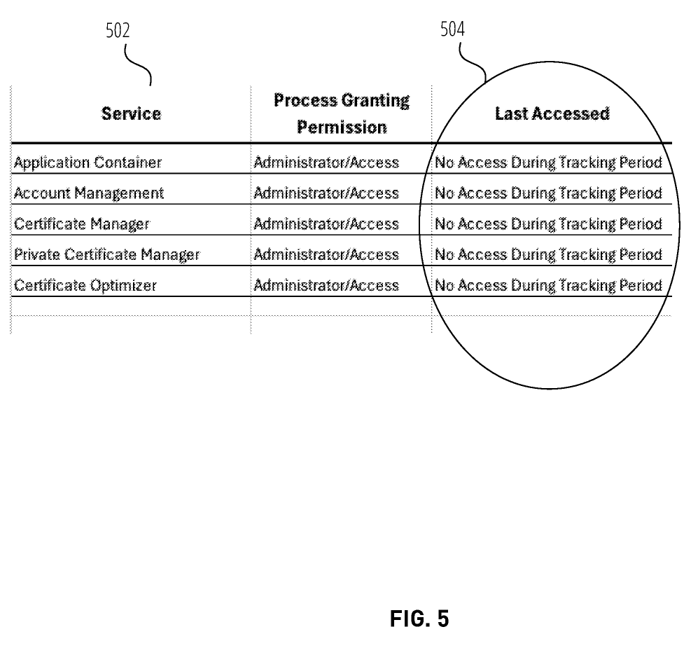

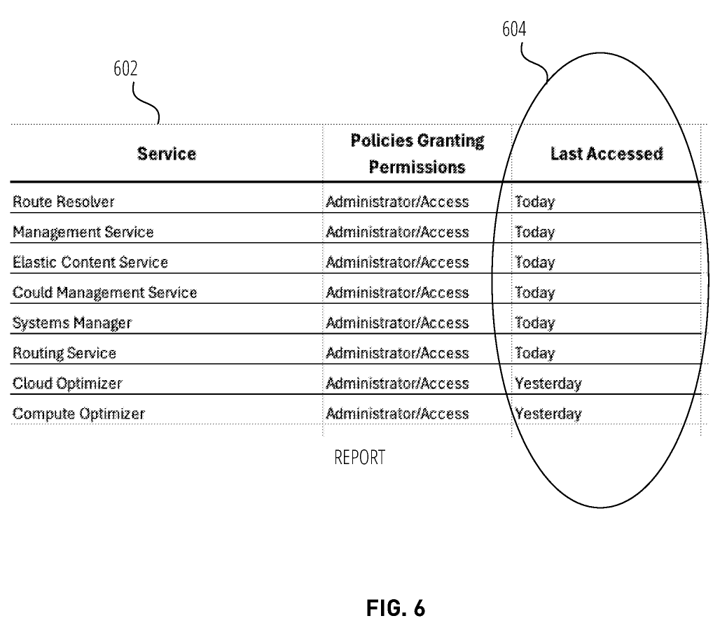

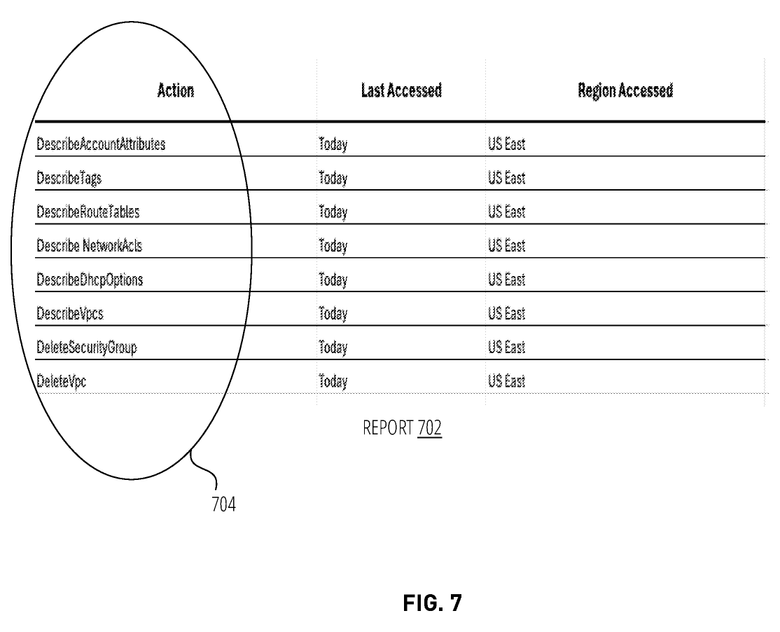

In an example, a report for the collected unused permissions is generated, 302. Various example reports are illustrated in FIG. 5, FIG. 6 and FIG. 7. Other types of reports and/or other formats can be supported. For example, a report can be presented as an email or in another messaging format, or a report can be presented in a dedicated status window/monitor. In an example, a usage window is applied to one or more permissions, for example, a single usage may be considered accidental and treated as if the corresponding permission had not been utilized.

Policies and/or roles are evaluated to determine if one or more policies and/or roles can be concatenated, 304, in light of the report of unused permissions (302). If no policies and/or roles can be concatenated, 304, then the process can end. In an example, when the flow ends, it can be repeated, for example, by returning to 206 in FIG. 2, in response to some triggering condition (e.g., a period of time, a explicit command, a change is some other condition). If one or more policies and/or roles can be concatenated, 304, then combination options to reduce the number of active roles and/or policies are evaluated, 306.

If the managing entity approves the merger/combination of one or more roles or permissions, 308, new roles and/or permissions are generated based on the merger(s), 310. The managing entity can be one or more of a system administrator, a set of rules or guidelines, an artificial intelligence (AI) or machine learning (ML) based agent or any combination thereof.

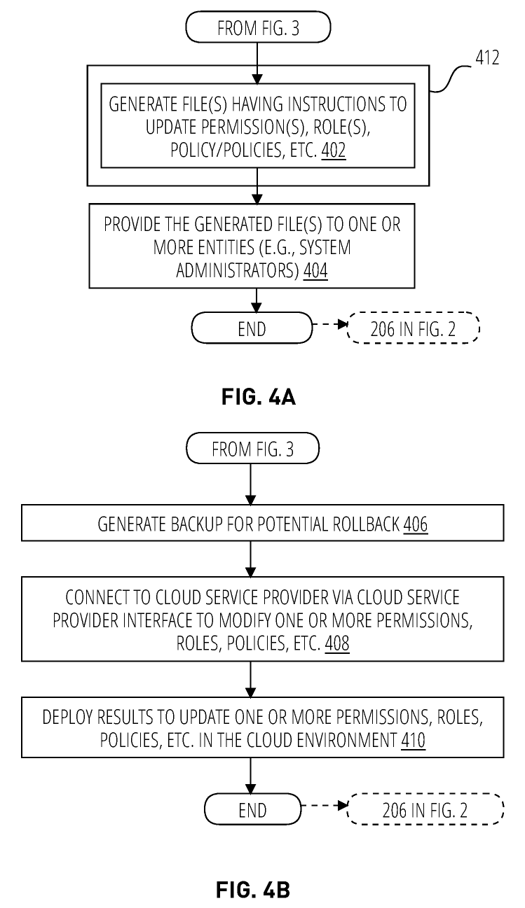

If the managing entity does not approve the merger/combination of one or more roles or permissions, 308, management tools are evaluated to determine if any of the management tools have permission to generate and/or delete roles and/or policies, 312. If the management tools do not have permission to generate/delete roles and/or permission, 312, the process continues as illustrated in FIG. 4A. If the management tools have permission to generate/delete roles and/or permission, 312, the process continues as illustrated in FIG. 4B.

FIG. 4A is a flow diagram of a portion of an approach to provide improved granularity least privilege access. The flow of FIG. 4A continues the flow of FIG. 3 when the management tools do not have permission to generate/delete roles and/or permissions (312 in FIG. 3).

In an example, when the management tools do not have permission to generate/delete roles and/or permissions, one or more files are generated having instructions to update permission(s), role(s), policies, etc., 402. These reports can be provided to (or processed via) cloud service provider interface 412. The one or more generated files can be provided to one or more entities associated with permission management (e.g., system administrators, report generators, analysis tools), 404, then the process can end. In an example, when the flow ends, it can be repeated, for example, by returning to 206 in FIG. 2, in response to some triggering condition (e.g., a period of time, a explicit command, a change is some other condition).

FIG. 4B is a flow diagram of a portion of an approach to provide improved granularity least privilege access. The flow of FIG. 4B continues the flow of FIG. 3 when the management tools have permission to generate/delete roles and/or permissions (312 in FIG. 3).

In an example, when the management tools do have permission to generate/delete roles and/or permissions, a backup is generated to support a potential future rollback, 406. A connection is established to the cloud service provide via one or more cloud service provider interfaces to modify one or more permissions, roles, policies, etc., 408. The cloud service provider environment is caused to deploy the changes based on the previously determined results (e.g., 306 in FIG. 3), 410. In an example, when the flow ends, it can be repeated, for example, by returning to 206 in FIG. 2, in response to some triggering condition (e.g., a period of time, a explicit command, a change is some other condition).

FIG. 5 illustrates a first example report. In the example of FIG. 5, report 502 lists permissions that have not been accessed 504. The example report as illustrated in FIG. 5 is just one simple example of the many reports that can be generated and used as described herein.

FIG. 6 illustrates a second example report. In the example of FIG. 6, report 602 lists last access times 604. The example report as illustrated in FIG. 6 is just one simple example of the many reports that can be generated and used as described herein.

FIG. 7 illustrates a third example report. In the example of FIG. 7, report 702 lists actions having corresponding permissions 704 and when the actions were last taken. The example report as illustrated in FIG. 7 is just one simple example of the many reports that can be generated and used as described herein.

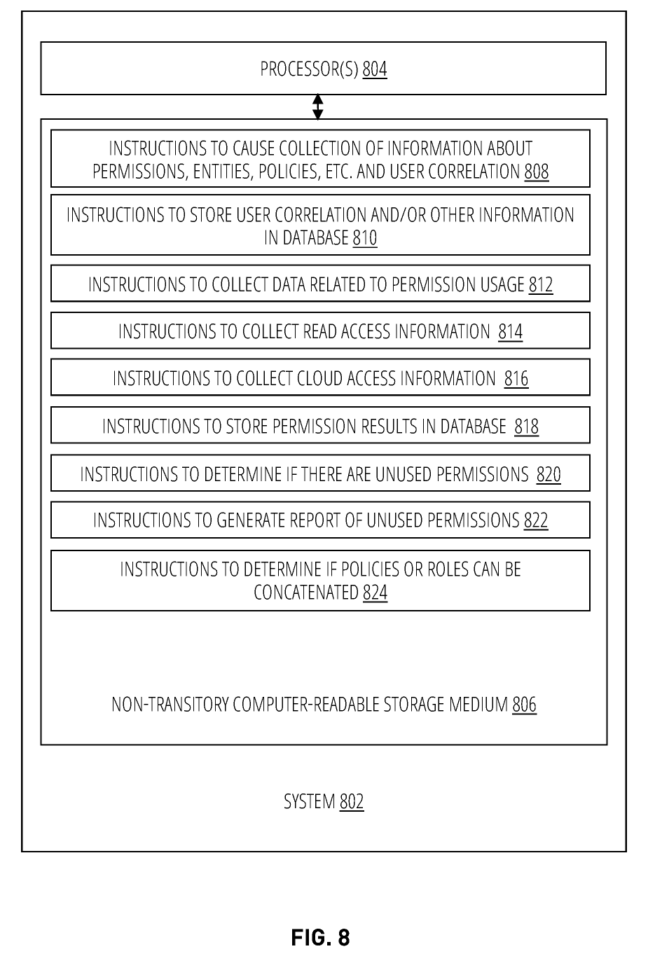

FIG. 8 is an example of a system to a portion of an approach to provide improved granularity least privilege access. In an example, system 802 can include processor(s) 804 and non-transitory computer-readable storage medium 806. Non-transitory computer-readable storage medium 806 may store instructions 808, 810, 812, 814, 816, 818, 820, 822 and 824 that, when executed by processor(s) 804, cause processor(s) 804 to perform various functions. Examples of processor(s) 804 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer-readable storage medium 806 include tangible media such as random-access memory (RAM), read-only memory (ROM), electrically erasable programmable read-only memory (EEPROM), flash memory, a hard disk drive, etc.

Instructions 808 cause processor(s) 804 to cause collection of information about entities, permissions and/or policies, etc. In an example, the collected information can be correlated to a user or other entity. Permissions can include, for example, access privileges for various files or services, characteristics of various entities authorized to access various files or services, groupings of entities having the same or similar permissions, roles of entities and corresponding permissions.

Instructions 810 cause processor(s) 804 to store user correlation and/or other information in a database.

Instructions 812 cause processor(s) 804 to collect data related to permission usage. Various techniques can be utilized to collect the permission usage information. Some example techniques are described below. In general, the specific permissions, permission properties, techniques for determining permission usage and/or interfaces for collecting information is at least partially dependent upon the cloud service provider being accessed. One example cloud service provider is Amazon Web Services, Inc. (AWS), which is a subsidiary of Amazon.com, Inc. of Bellevue, Washington, USA.

Instructions 814 cause processor(s) 804 to collect read access information. In an example, read access information is collected for roles, users, policies and/or user groups. Additional and/or different information can also be collected.

Instructions 816 cause processor(s) 804 to collect cloud access information. In an example, cloud access information is collected for roles, users, policies and/or user groups. Additional and/or different information can also be collected.

Instructions 818 cause processor(s) 804 to store permission results in the database. In an example, the permission results include the read access information, the cloud access information, analytical results based on the read access information and/or the cloud access information, and/or other relevant information.

Instructions 820 cause processor(s) 804 to determine if there are unused permissions.

Instructions 822 cause processor(s) 804 to generate a report if unused permissions are found. Various example reports are illustrated in FIG. 5, FIG. 6 and FIG. 7. Other types of reports and/or other formats can be supported. For example, a report can be presented as an email or in another messaging format, or a report can be presented in a dedicated status window/monitor.

Instructions 824 cause processor(s) 804 to determine if one or more policies and/or roles can be concatenated.

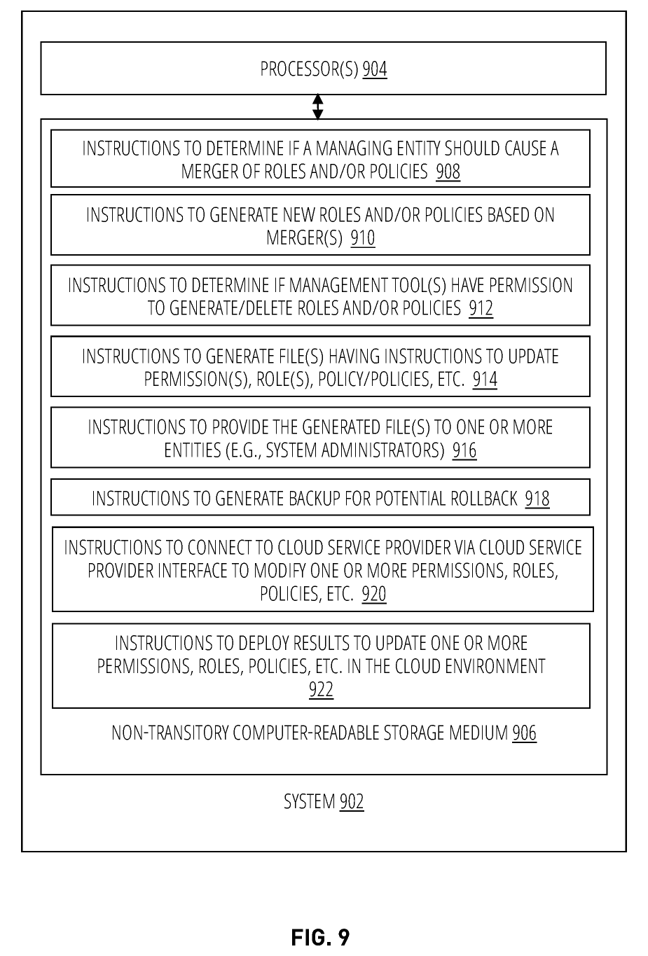

FIG. 9 is an example of a system to a portion of an approach to provide improved granularity least privilege access. In an example, system 902 can include processor(s) 904 and non-transitory computer-readable storage medium 906. Non-transitory computer-readable storage medium 906 may store instructions 908, 910, 912, 914, 916, 918 and 920 that, when executed by processor(s) 904, cause processor(s) 904 to perform various functions. Examples of processor(s) 904 may include a microcontroller, a microcontroller, a microprocessor, a CPU, a GPU, a DPU, an ASIC, a FPGA, a SoC, etc. Examples of non-transitory computer-readable storage medium 906 include tangible media such as RAM, ROM, EEPROM, flash memory, a hard disk drive, etc.

Instructions 908 cause processor(s) 904 to if a managing entity should cause a merger of one or more roles and/or policies. If the managing entity approves the merger/combination of one or more roles or policies new roles and/or policies are generated based on the merger(s) as a result of processor(s) 904 executing instructions 910. The managing entity can be one or more of a system administrator, a set of rules or guidelines, an artificial intelligence (AI) or machine learning (ML) based agent or any combination thereof.

Instructions 912 cause processor(s) 904 to determine if one or more management tools have permission to generate and/or delete role(s) and/or policies.

Instructions 914 cause processor(s) 904 to generate one or more files having instructions to update permission(s), role(s), policies, etc.

Instructions 916 cause processor(s) 904 to provide the generated files to one or more entities. The one or more generated files can be provided to one or more entities associated with permission management (e.g., system administrators, report generators, analysis tools).

Instructions 918 cause processor(s) 904 to generate a backup should a rollback be attempted in the future.

Instructions 920 cause processor(s) 904 to connect to a cloud service provider via one or more cloud service provider interfaces to modify one or more permissions, roles, policies, etc.

Instructions 922 cause processor(s) 904 to deploy the results to update the one or more permissions, roles, policies in the cloud environment.

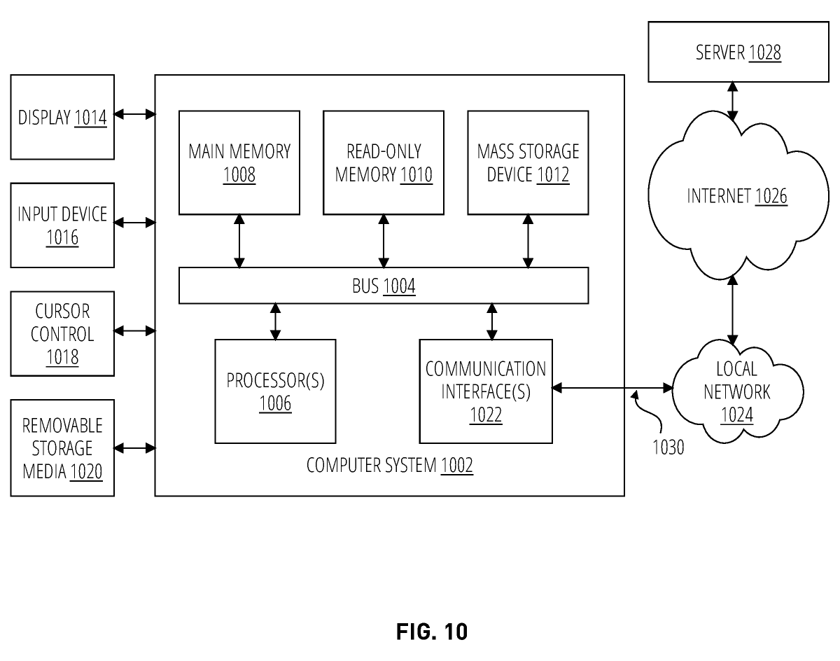

FIG. 10 is a block diagram that illustrates a computer system in which or with which an embodiment of the present disclosure may be implemented. Computer system 1002 may be representative of an endpoint or client device (e.g., one of the off-net clients or on-net clients) on which an endpoint security agent is running and acting as a proxy on behalf of a client application (e.g., a browser). Notably, components of computer system 1002 described herein are meant only to exemplify various possibilities. In no way should example computer system 1002 limit the scope of the present disclosure. In the context of the present example, computer system 1002 includes bus 1004 or other communication mechanism for communicating information and one or more processing resources (e.g., one or more hardware processor(s) 1006) coupled with bus 1004 for processing information. Hardware processor(s) 1006 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In some examples, one or more processing resources may be part of an ASIC-based security processing unit (e.g., the FORTISP family of security processing units available from Fortinet, Inc. of Sunnyvale, CA).

Computer system 1002 also includes main memory 1008, such as a random-access memory (RAM) or other dynamic storage device, coupled to bus 1004 for storing information and instructions to be executed by processor(s) 1006. Main memory 1008 also may be used for storing temporary variables or other intermediate information during execution of instructions to be executed by processor(s) 1006. Such instructions, when stored in non-transitory storage media accessible to processor(s) 1006, render computer system 1002 into a special-purpose machine customized to perform the operations specified in the instructions.

Computer system 1002 includes a read-only memory 1010 or other static storage device coupled to bus 1004 for storing static information and instructions for processor(s) 1006. Mass storage device 1012 (e.g., a magnetic disk, optical disk or flash disk (made of flash memory chips), is provided and coupled to bus 1004 for storing information and instructions.

Computer system 1002 may be coupled via bus 1004 to display 1014 (e.g., a cathode ray tube (CRT), Liquid Crystal Display (LCD), Organic Light-Emitting Diode Display (OLED), Digital Light Processing Display (DLP) or the like, for displaying information to a computer user. Input device 1016, including alphanumeric and other keys, is coupled to bus 1004 for communicating information and command selections to processor(s) 1006. Another type of user input device is cursor control 1018, such as a mouse, a trackball, a trackpad, or cursor direction keys for communicating direction information and command selections to processor(s) 1006 and for controlling cursor movement on display 1014. This input device typically has two degrees of freedom in two axes, a first axis (e.g., x) and a second axis (e.g., y), that allows the device to specify positions in a plane.

Removable storage media 1020 can be any kind of external storage media, including, but not limited to, hard-drives, floppy drives, IOMEGA® Zip Drives, Compact Disc – Read Only Memory (CD-ROM), Compact Disc – Re-Writable (CD-RW), Digital Video Disk – Read Only Memory (DVD-ROM), USB flash drives and the like.

Computer system 1002 may implement the techniques described herein using customized hard-wired logic, one or more ASICs or FPGAs, firmware or program logic which in combination with the computer system causes or programs computer system 1002 to be a special-purpose machine. According to one embodiment, the techniques herein are performed by computer system 1002 in response to processor(s) 1006 executing one or more sequences of one or more instructions contained in main memory 1008. Such instructions may be read into main memory 1008 from another storage medium, such as mass storage device 1012. Execution of the sequences of instructions contained in main memory 1008 causes processor(s) 1006 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic, or flash disks, such as mass storage device 1012. Volatile media includes dynamic memory, such as main memory 1008. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 1004. Transmission media can also be acoustic or light waves, such as those generated during radio-wave and infrared data communications.

Various forms of media may be involved in carrying one or more sequences of one or more instructions to processor(s) 1006 for execution. For example, the instructions may initially be carried on a magnetic disk or solid-state drive of a remote computer. The remote computer can load the instructions into its dynamic memory and send the instructions over a telephone line using a modem. A modem local to computer system 1002 can receive the data on the telephone line and use an infra-red transmitter to convert the data to an infra-red signal. An infra-red detector can receive the data from the infra-red signal, and appropriate circuitry can place the data on bus 1004. Bus 1004 carries the data to main memory 1008, from which processor(s) 1006 retrieve and execute the instructions. The instructions received by main memory 1008 may optionally be stored on mass storage device 1012 either before or after execution by processor(s) 1006.

Computer system 1002 also includes communication interface(s) 1022 coupled to bus 1004. Communication interface(s) 1022 provides a two-way data communication coupling to network link 1030 that is connected to local network 1024. For example, communication interface(s) 1022 may be an integrated services digital network (ISDN) card, cable modem, satellite modem, or a modem to provide a data communication connection to a corresponding type of telephone line. Another example is communication interface(s) 1022, which may be a local area network (LAN) card that provides a data communication connection to a compatible LAN. Wireless links may also be implemented. In any such implementation, communication interface(s) 1022 sends and receives electrical, electromagnetic or optical signals that carry digital data streams representing various types of information.

Network link 1030 typically provides data communication through one or more networks to other data devices. Local network 1024 and internet 1026 both use electrical, electromagnetic or optical signals that carry digital data streams. The signals through the various networks and network link 1030 and through communication interface(s) 1022, which carry the digital data to and from computer system 1002, are example forms of transmission media.

Computer system 1002 can send messages and receive data, including program code, through the network(s), network link 1030 and communication interface(s) 1022. In the Internet example, server 1028 might transmit a requested code for an application program through internet 1026, local network 1024 and communication interface(s) 1022. The received code may be executed by processor(s) 1006 as it is received or stored in mass storage device 212 or other non-volatile storage for later execution.

Embodiments may be implemented as any or a combination of one or more microchips or integrated circuits interconnected using a parent board, hardwired logic, software stored by a memory device and executed by a microprocessor, firmware, an application-specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include but is not limited to, floppy diskettes, optical disks, CD-ROMs (Compact Disc-Read Only Memories), magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as the following claims.

Reference in the specification to “one example” or “an example” means that a particular feature, structure, or characteristic described in connection with the example is included in at least one embodiment of the disclosure. The appearances of the phrase “in one example” in various places in the specification do not necessarily refer to the same embodiment.

It is contemplated that any number and type of components may be added to and/or removed to facilitate various embodiments, including adding, removing, and/or enhancing certain features. For brevity, clarity, and ease of understanding, many standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component,” “module,” “system,” and the like as used herein are intended to refer to a computer-related entity, either software-executing general-purpose processor, hardware, firmware, or a combination thereof. For example, a component may be, but is not limited to, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer-readable media with various data structures stored thereon. The components may communicate via local and/or remote processes, such as in accordance with a signal having one or more data packets (e.g., data from one component interacting with another component in a local system, distributed system, and/or across a network such as the Internet with other systems via the signal).

Computer-executable components can be stored, for example, on non-transitory, computer-readable media including, but not limited to, an ASIC, CD, DVD, ROM, floppy disk, hard disk, EEPROM, memory stick or any other storage device type, in accordance with the claimed subject matter.

What is claimed is:

1. A non-transitory computer-readable medium having stored thereon instructions that, when executed by one or more processors, cause the one or more processors to:
collect data corresponding to the usage of permissions, wherein the permissions are utilized to access resources in a cloud-based computing environment that provides secure resources and services based, at least in part, on permissions associated with a requesting entity;
analyze the collected data utilizing one or more pre-selected parameters to determine usage levels for the permissions;
evaluate whether one or more of the determined usage levels for the permissions is outside of a usage window for the corresponding permissions;
generate a report of permissions having usage levels outside of the usage window for the corresponding permissions; and
transmit the report to an entity having some responsibility with respect to the usage of permissions.

2. The non-transitory computer-readable medium of claim 1, further comprising instructions that, when executed by the one or more processors, cause the one or more processors to cause permissions to be modified within the cloud-based computing environment based on the report.

3. The non-transitory computer-readable medium of claim 1, wherein the data collected further comprises data corresponding to user groups, roles, and policies.

4. The non-transitory computer-readable medium of claim 1, wherein the permissions comprise one or more of user permissions, device permissions, organization permissions and geographic permissions.

5. The non-transitory computer-readable medium of claim 1, wherein mechanisms of the cloud-based computing environment assign the permissions utilized to access resources in the cloud-based computing environment.

6. The non-transitory computer-readable medium of claim 1, wherein mechanisms of the cloud-based computing environment manage the permissions utilized to access resources in the cloud-based computing environment.

7. The non-transitory computer-readable medium of claim 1, wherein the one or more pre-selected parameters comprises a period of time.

8. A method comprising:
collecting data corresponding to the usage of permissions, wherein the permissions are utilized to access resources in a cloud-based computing environment that provides secure resources and services based, at least in part, on permissions associated with a requesting entity;
analyzing the collected data utilizing one or more pre-selected parameters to determine usage levels for the permissions;
evaluating whether one or more of the determined usage levels for the permissions is outside of a usage window for the corresponding permissions;
generating a report of permissions having usage levels outside of the usage window for the corresponding permissions; and
transmitting the report to an entity having some responsibility with respect to the usage of permissions.

9. The method of claim 8 further comprising causing the one or more processors to cause permissions to be modified within the cloud-based computing environment based on the report.

10. The method of claim 8, wherein the data collected further comprises data corresponding to user groups, roles, and policies.

11. The method of claim 8, wherein the permissions comprise one or more of user permissions, device permissions, organization permissions and geographic permissions.

12. The method of claim 8, wherein mechanisms of the cloud-based computing environment assign the permissions utilized to access resources in the cloud-based computing environment.

13. The method of claim 8, wherein mechanisms of the cloud-based computing environment manage the permissions utilized to access resources in the cloud-based computing environment.

14. The method of claim 8, wherein the one or more pre-selected parameters comprises a period of time.

15. A system comprising:
a memory system having a plurality of interconnected memory devices;
one or more hardware processors coupled with the memory system, the one or more hardware processors configurable to:
collect data corresponding to the usage of permissions, wherein the permissions are utilized to access resources in a cloud-based computing environment that provides secure resources and services based, at least in part, on permissions associated with a requesting entity;
analyze the collected data utilizing one or more pre-selected parameters to determine usage levels for the permissions;
evaluate whether one or more of the determined usage levels for the permissions is outside of a usage window for the corresponding permissions;
generate a report of permissions having usage levels outside of the usage window for the corresponding permissions; and
transmit the report to an entity having some responsibility with respect to the usage of permissions.

16. The system of claim 15 wherein the one or more hardware processors is further configured to cause the one or more processors to cause permissions to be modified within the cloud-based computing environment based on the report.

17. The system of claim 15, wherein the data collected further comprises data corresponding to user groups, roles, and policies.

18. The system of claim 15, wherein the permissions comprise one or more of user permissions, device permissions, organization permissions and geographic permissions.

19. The system of claim 15, wherein mechanisms of the cloud-based computing environment assign the permissions utilized to access resources in the cloud-based computing environment.

20. The system of claim 15, wherein the one or more pre-selected parameters comprises a period of time.
